(19) United States
(12) Patent Application Publication
(10) Pub. No.: US 2003/0191647 A1
(43) Pub. Date: Oct. 9, 2003

(54) Method & system for managing web pages, and telecommunications via multilingual keywords and domains

(76) Inventor: David M. Kam, Montreal (CA)

Correspondence Address: David M. Kam, 2970 Thomas Valin, Montreal, QC, H2K 4R7, CA

(21) Appl. No.: 10/115,631

(22) Filed: Apr. 5, 2002

(51) Int. Cl. G10L 15/04; G06F 17/27; G10L 21/00

(52) U.S. Cl. 704/270.1; 704/251

(57) ABSTRACT

Method, and systems for managing Web sites, domain names, keywords, IP addresses, and telephone numbers on a global computer network, including to: (a) automatically locate Web pages that: cannot be found, has moved, does not exist anymore or is lost; (b) allow users to locate a Web sites, by inputting multi-lingual keywords, and multilingual domain names to any regular Web browser, in which the resolution is a server side solution; (c) enable peer-to-peer Web sites; (d) use a domain name, instead of telephone number to call and to communicate with another user, using voice over IP or data over IP; (e) allow for unified communications, via domain names and keywords.

### BACKGROUND—FIELD OF INVENTION

This present invention relates generally to methods, and systems of locating computer sites, including Web pages that has moves, is missing or does not exist anymore via a global computer network, using including intelligent devices such as computers. Furthermore, it includes methods, and systems of calling a party via a telecommunication device, such as a telephone, without using a telephone number, but instead using a multilingual domain name or a keyword; this facilitates high speed telecommunications via voice over Internet Protocol (IP) and data over IP.

### BACKGROUND DESCRIPTION OF PRIOR ART

Web sites are mainly accessed via Internet ready devices, such as computers; the user usually goes through the following steps: (1) the user turns on the Internet ready device; (2) opens up a web browser; (3) logs onto the Internet; (4) enter a URL address into the browser, such as www.yourdomain-name.com; (5) then the domain names are sent to a Domain Name Service (DNS) server to find the matching Internet Protocol (IP) number; (6) then afterwards, the IP number is used to locate, and to retrieve the Web site, to displayed to the user.

Often the user is frustrated due to Web pages or sites that do not exist anymore or have moved, resulting in a page saying “The page cannot be displayed”. This is a waste of time, and energy.

Furthermore, with the Internet growing exponentially, it becomes increasingly difficult to locate relevant Web sites. There are over 1,000 domain name extensions, and growing, such as .com, .net, .ca, .co.uk, plc.uk, . . . etc. For exemplary purposes, a domain name, such as “car.com”, and “car.plc.uk” might lead to two different Web sites. Most users cannot remember the domain name extensions. REALNAMES, partly owned by MICROSOFT, has introduced a Internet KEYWORD system to locate Web site, using words for example “car” to locate a Web site, but it works only on proprietary the MICROSOFT INTERNET EXPLORER browser, since this is a client based solution (browser actuated solution). Not everybody has a Java enabled browser like MICROSOFT INTERNET EXPLORER. Therefore, it would be a great benefit for the Internet user to minimize getting Web pages that do not exist anymore or have moved. Consequently, to be able to locate a Web site 100% of the time, using any Web enabled device, would result in a more efficient use of time, and energy, thus increasing user's enjoyment of the Internet.

Furthermore, it would be extremely beneficial to be able to locate Web sites, using keywords, words, and characters in a plurality of languages, that does not require the use of a proprietary Web browser, such as MICROSOFT INTERNET EXPLORER. Also, REALNAMES' keywords are not multilingual, but uses only Latin characters A to Z, 0 to 9. Furthermore, REALNAMES do not use Domain Name Service (DNS) root servers for resolution, so it is slow.

Another aspect of prior art is in regards to telephone numbers, people now can dial an easy to remember 1-800-number, such as 1-800-flowers to call a company. The 1-800-number is generally not available to the individual user, so they have to fall back to remembering difficult numbers, instead of names. How many phone numbers can a person remember? Often a person cannot call someone because they forgot the phone number.

Consequently, it would be a great benefit for users to not have to dial a telephone number to call another party, but instead would dial easy to remember names into a telephone, in a plurality of languages, such as “JohnSmith.tel” or “JohnSmith*info” or “John Smith” or [symbol] .tel.

Therefore, it is desirable to provide methods, and systems to make the Internet experience more friendly, simple, efficient, easy, fast, and accessible in a plurality of languages.

### SUMMARY

In accordance with this present invention of managing words, names, addresses, computer sites, telephone numbers, and search engines, several objects and advantages of the present invention are as follows:

Note that the use of the term “keyword”, “Keyword” and “Word” in this invention, and this document shall have the following meaning, including either alone or in combination with word and/or words and/or character and/or symbols, and/or numbers, in a plurality of languages;

### OBJECTS, AND ADVANTAGES

(a) Accordingly, a aspect of this present invention, includes a multi-lingual keyword system for locating Web sites, without the need of any additional end user software other than a regular Web browser, and the browser is not proprietary;

(b) Accordingly, a aspect of this present invention, includes a multi-lingual domain name system for locating Web sites, without the need of any additional end user software other than a regular Web browser;

(c) Accordingly, a aspect of this present invention, includes a system for locating a Web site, even if the Web page has moved;

(d) Accordingly, a aspect of this present invention, includes a system for automatically converting a domain name to a keyword, in a plurality of languages;

(e) Accordingly, a aspect of this present invention, includes a system for automatically matching the said newly converted keyword of paragraph (d) to a Internet Protocol (IP) address, for locating a Web site;

(f) Accordingly, a aspect of this present invention, includes a system for re-directing a URL or domain name or keyword for a Web page that does not exist, to a Web page that does exist;

(g) Accordingly, a aspect of this present invention, includes a system for re-directing a domain name or keyword for a Web page that does not exist to a general search engine, which then displays a Web page with the search results for the domain name or keyword that was automatically inputted, and processed by the search engine;

(h) Accordingly, a aspect of this present invention, includes a system for matching a domain name to a telephone number;

(i) Accordingly, a aspect of this present invention, furthermore includes a system for matching a telephone number to a Internet Protocol (IP) address;

(j) Accordingly, a aspect of this present invention, includes a system for dialing a domain name or a keyword into a telephone to reach another party;

(k) Accordingly, another aspect of this present invention provides methods, and systems for a telecommunications based domain name system;

(l) Accordingly, another aspect of this present invention provides methods and systems for storing telephone records, their corresponding domain names, and computer server addresses used for telecommunications, within Domain Name Service (DNS) records;

(m) Accordingly, another aspect of this present invention provides methods and systems for processing telephone records, their corresponding domain names, and computer server addresses used for telecommunications, within Domain Name Service (DNS) software;

(n) Accordingly, another aspect of this present invention provides methods and systems for storing keywords, and computer server addresses within Domain Name Service (DNS) records;

(o) Accordingly, another aspect of this present invention provides methods and systems for processing keywords, and computer server addresses, within Domain Name Service (DNS) software;

Although various preferred embodiments have been described herein in detail, it is appreciated by those skilled in art, that variations may be made hereto without departing from the spirit of this invention or scope of the appended claims, privilege is claimed herein. Other objects, together with the foregoing are attained in the exercise of the method described in the following description, and resulting in the embodiment illustrated in the accompanying drawing. Still further objects, and advantages will become apparent from a consideration of the ensuing description, and accompanying drawings.

### DRAWING FIGURES

FIG. 1 is a illustration of “The page cannot be displayed”; this is what a Internet user normally sees when a Web page cannot be found;

FIG. 2 is a flowchart, showing an exemplary system for locating, and matching a unique domain name and/or keyword to a Internet Protocol (IP) address, in order to access a web page or a general search engine;

FIG. 3 is a flowchart, showing an exemplary system for converting a domain name to a keyword;

FIG. 4-A, and FIG. 4-B is respectively, an illustration of a Root File, and a Zone File, showing an exemplary system for storing a keyword record, including a multilingual keyword their corresponding computer address, and name server address within a Domain Name Service (DNS) software;

FIG. 5-A, and FIG. 5-B is respectively an illustration of a Root File, and a Zone File, showing an exemplary system for storing a telephone record, including a telephone number, a name server address, and their corresponding multilingual domain name in a Domain Name Service (DNS) software;

### DESCRIPTION

The words First Name Server, Second Name Server, Keyword Server, Resolver, Name Server at ISP, and Telephone name server are used for identification only; it can be called by any other name.

### I. INTRODUCTION

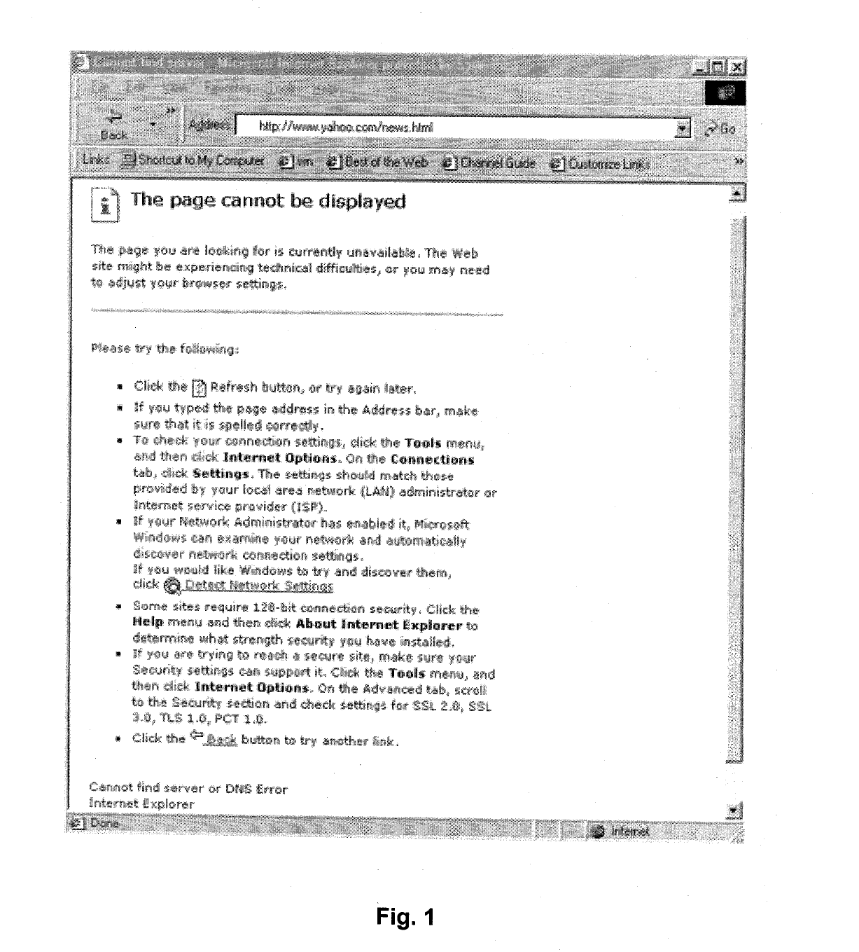

FIG. 1 is an illustration of “The page cannot be displayed”; this is what a Internet user normally sees when a Web page cannot be found. This usually happens when a Web page has moved or does not exist anymore or is lost. This present invention is to minimize these type of useless pages, so that Web pages can always be found.

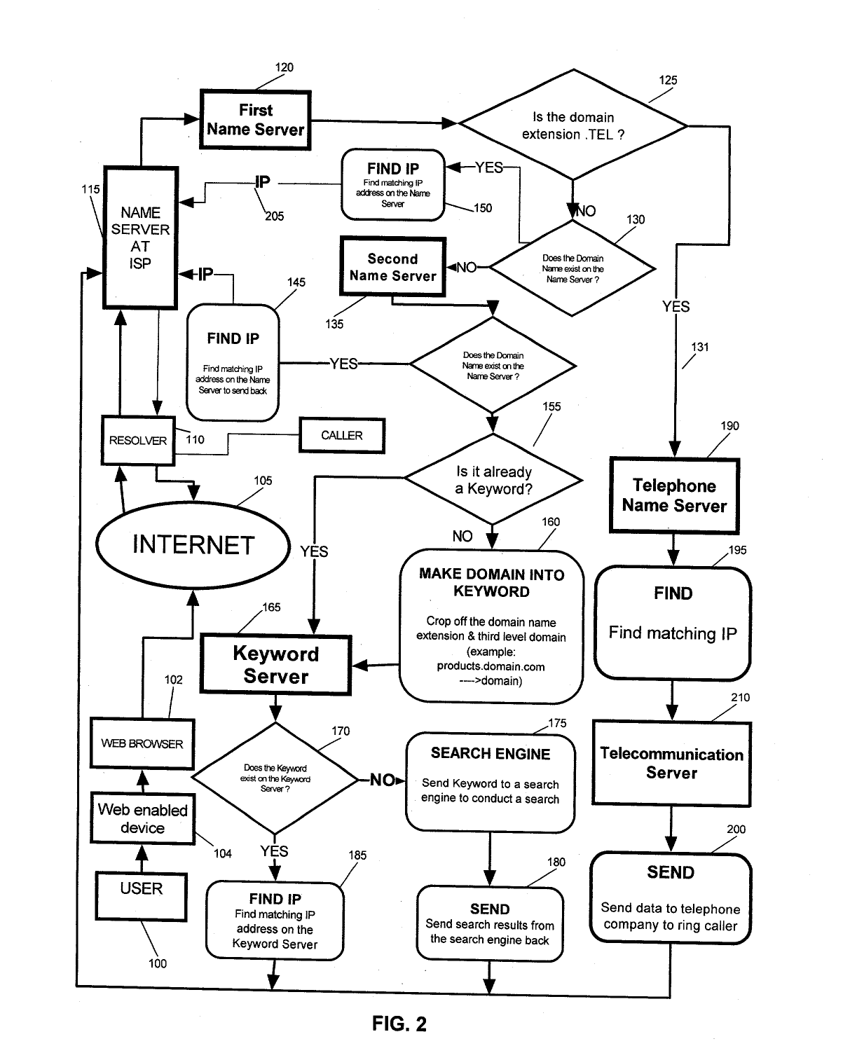

FIG. 2 is a flowchart, showing an exemplary system for locating, and matching a unique keyword and/or a unique domain name, in a plurality of languages, to a Internet Protocol (IP) address, for locating computer sites;

Furthermore, it includes an exemplary system for converting a domain name to a keyword, in the event a matching IP address for the domain name cannot be found; this is in order to locate Web pages or Web sites that has moved or has changed or has been lost;

Furthermore, if a matching IP address cannot be found for the keyword in the Keyword Server, then the keyword is further sent to a general search engine, such as YAHOO or LOOKSMART . . . etc.; the user will receive the search results from the general search engine so that the have more relevant searches, instead of getting a “The page cannot be displayed” page;

Furthermore, it includes an exemplary system for using a domain name or keyword as an alternative to a telephone number to call another person;

### II. RESOLVING A DOMAIN NAME

With this system, and method, comprising of User 100 (hereinafter called “User”) accessing a communications network, which in the preferred embodiment is the globally interconnected computer network, known as the Internet 105; User accesses Internet 105 via a Browser 102 on a Internet access device, which in the preferred embodiment is a Personal Computer 104 or alternatively a cellular phone; Browser 300 of FIG. 2 is a multi-lingual Web browser. To locate a Web site, the User does the following: (i) User enters a domain name or a keyword by typing it into Slot 305. For exemplary purposes we have chosen the following domain name:

(i) “cars.name”, (ii) “products.chocolates.inc”, (iii) “JohnSmith.tel”, and the keyword example (iv) “japan”. Next the User then actuate “OK” button 310;

The domain name is sent via the Internet 105, to a plurality of servers, called a Resolver 110, which is usually located at an Internet Service Provider (ISP). Resolver 110 will then communicate with the appropriate Name Server at ISP 115 or some other name server as specified by the User's name server settings (also called “DNS settings”).

The domain names or keywords is sent to First Name Server 120, including to a root server, for resolution (resolution means to find the IP address).

First Server 120, searches it's database (also called “zone files”) to see if its is authoritative or in control of the domain extension.

### EXAMPLE (i)

In the case of domain name example “cars.name”, First Server 120 searches its database to see if it is authoritative for the “.name” extension. Since the domain extension “.name” is in First Server 120's database, which it is authoritative. Since First Name Server 120 is authoritative, it searches for the IP address for “cars.name”.

There are 2 scenarios: (i) if the matching IP address is found for “cars.name”, then the IP address is sent back 205 to Name Server at ISP 115; (ii) if no IP address is found in First Name Server 120, then the domain name

“cars.name” is delegated, and sent to Second Name Server 135 for resolution;

### EXAMPLE (ii)

In the case of domain name example “products.chocolate.inc”, First Name Server 120 searches its database to see if it is authoritative for the “.inc” extension. Since the domain extension “.inc” is in First Name Server 120's database, which it is authoritative for “.inc”.

Furthermore, there are 2 scenerios: (i) First Name Server 120 discovers it is not authoritative for the second level domain “.chocolate”, since the third level domain “.products” still needs to be resolved. Then the domain name “products.chocolate.inc” is delegated, and sent to the appropriate name server listed in First Name Server 120's database, which is authoritative for the second level domain “.chocolate”, which for exemplary purposes, the Second Name Server 135 is authoritative for “.chocolate”;

(ii) First Name Server 120 discovers it is authoritative for the second level domain “.chocolate”, as well as “.inc”, since the both the first level domain “.inc”, and the second level domain “.chocolate” is in its database. Since First Name Server 120 is authoritative, it searches for the IP address for “products.chocolate.inc”. There are 2 scenarios: (i) if the matching IP address is found for “products.chocolate.inc”, then the IP address is sent back 205 to Name Server at ISP 115; (ii) if no IP address is found in First Name Server 120, then the domain name “products.chocolate.inc” is delegated, and sent to Second Name Server 135 for resolution;

### EXAMPLE (iii)

In the case of domain name example “JohnSmith.tel”, First Name Server 120 searches its database to see if it is authoritative for the “.tel” extension. Since the domain extension “.tel” is used for telephone communications, the domain name “JohnSmith.tel” is delegated or sent to Telephone Server 190 for resolution.

### EXAMPLE (iv)

In the case of keyword example “japan”, First Name Server 120 searches its database to see if it is authoritative, for the “japan” extension. Since First Name Server 120 is not authoritative, the keyword “japan” is delegated or sent to sent to Second Name Server 135.

Second Name Server 135 searches its database to see if it is authoritative, for the “japan” extension. Since Second Name Server 120 is not authoritative, the keyword “japan” is delegated or sent to Keyword Server 160.

### RESOLVING A KEYWORD

A. Already a Keyword (and Resolving the Keyword)

If data 155 being sent from Second Name Server 135 to Keyword Server 165 is a keyword, such as “japan”, then Keyword Server 165 searches 170 for the matching IP address for “japan”.

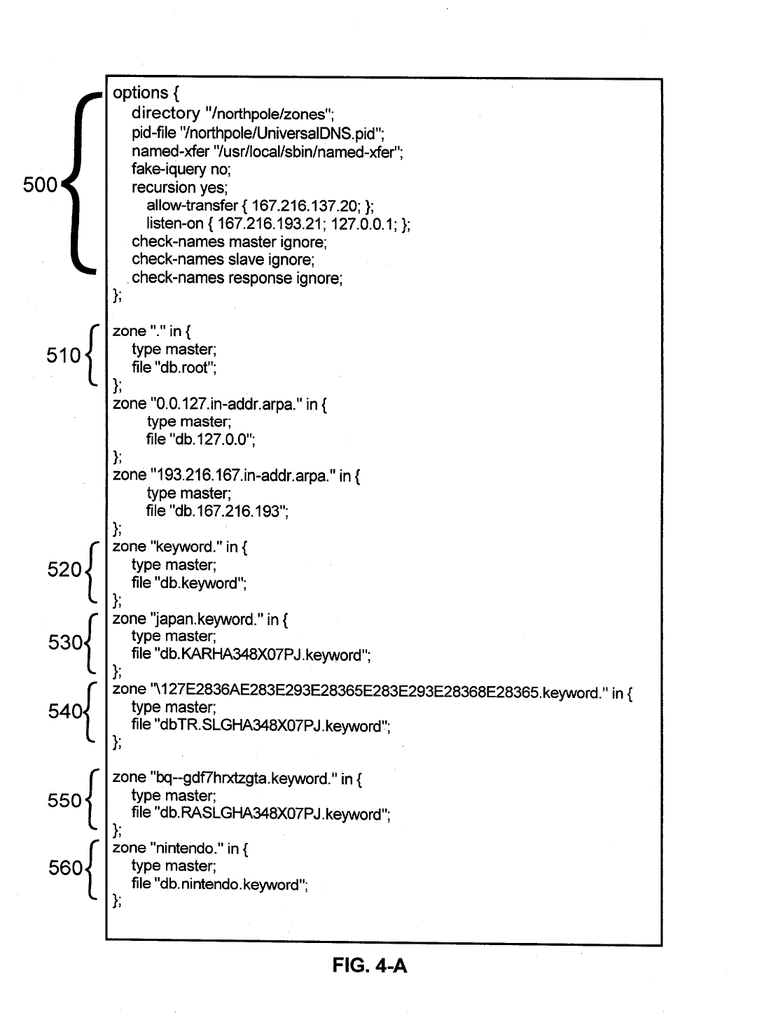

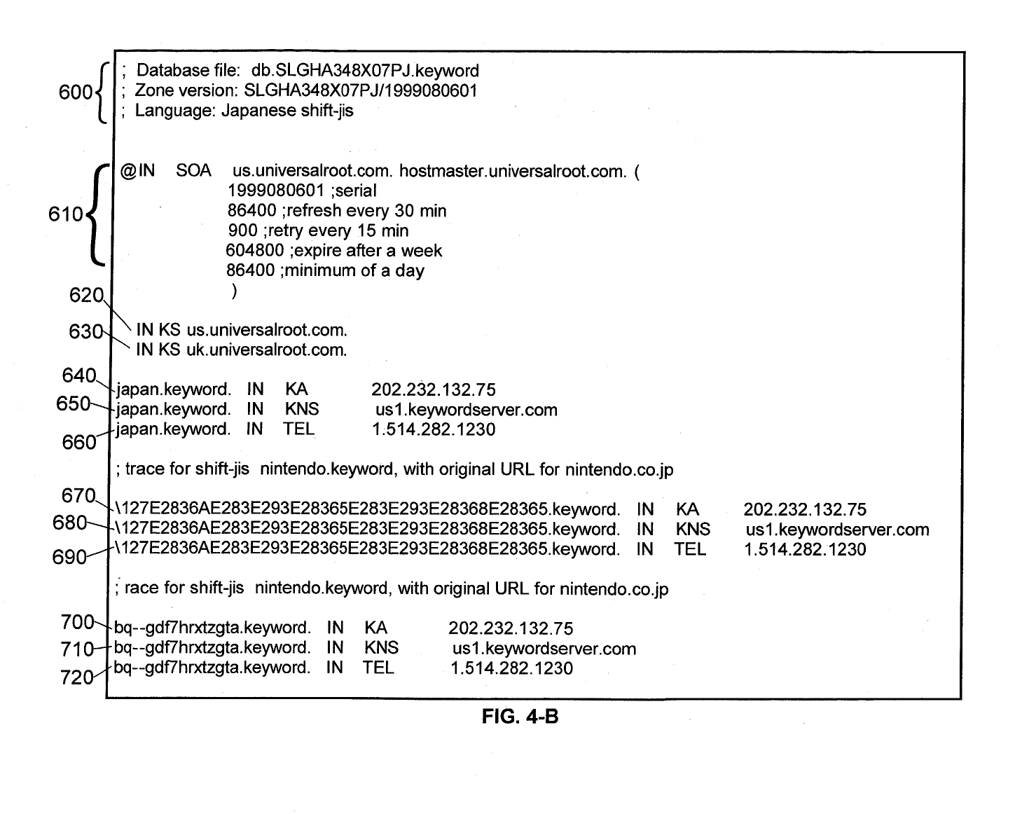

(i) An Exemplary System for Storing Keyword Records in a Root File of a Keyword Server, comprises of a Domain Name Server (DNS) software modified through this invention to support keywords, comprising of a Root File as shown in FIG. 4-A. A standard configuration setting for a Domain Name Server (DNS) software, such as BIND is shown in 500 of FIG. 4-A.

The standard Domain Name Server (DNS) software has the recursion turned off, as indicated by setting it to “no”, but we will turn on the recursion by setting it to “yes”. In this example, the Keyword Server is shown as a root server, as indicated by 510 the root zone “.”; information for the “.” root zone is stored in the zone file called “db.root”. However, it is not necessarily the Keyword Server is a root server.

The DNS software has been modified to add a dot keyword “.keyword” to the end of a keyword, if no dot “.” exist. The exemplary keyword “japan” becomes “japan.keyword”. The first level zone 520 is “.keyword”; information for the “.keyword” first level zone is stored in the zone file called “db.keyword”.

The second level zone, contains 5 examples, 530, 540, 550, 560, 570.

(a) Example 530 of a second level zone, is the English keyword “japan”, is stored as “japan.keyword”; the “.keyword” portion of “japan.keyword” is invisible to an end user. Therefore, what users see in their Web browser is “japan”.

(b) Example 540 of a second level zone, is the Japanese keyword [symbol] in shift-jis character encoding, stored as an ASCII representation in Trace format: “├127E2836AE283E293E28365E283E293E28368E28365.keyw ord”. Information for the “├127E2836AE283E293E28366E283E293E28368E28365.keyw ord” second level zone is stored in the zone file called “db.TRSLGHA348X07PJ.keyword”, where “TRSLGHA348X07PJ” is a unique serial number assigned as a filename. The “.keyword” portion is invisible to an end user. Therefore, people see in their Web browser is [symbol] .

(c) Example 550 of a second level zone, is the Japanese keyword [symbol] in shift-jis character encoding, stored as an ASCII representation in Race format, an alternative to Trace: “bq—gdf7hrxtzgta.keyword”. Information for the “bq—gdf7hrxtzgta.keyword” second level zone is stored in the zone file called “db.RASLGHA348X07PJ.keyword”, where “RASLGHA348X07PJ” is a unique serial number assigned as a filename. The “.keyword” portion is invisible to an end user. Therefore people see in their Web browser is [symbol] .

(d) Example 560 is an alternative representation of a zone; The English keyword “nintendo”, is stored as “nintendo”, instead of “nintendo.keyword”. This would require to modify the DNS software to recognize all words, without a dot “.” as a second level zones. Information for the “nintendo” second level zone is stored in the zone file called “db.ninetndo.keyword”.

(ii) An Exemplary System of Storing the db. Zone File in a Keyword Server, comprises of a Domain Name Server (DNS) software modified through this invention to support keywords, comprising of a Zone File as shown in FIG. 4-B includes 600 comments. The standard Start of Authority (SOA) 610.

(a) The name of the primary Keyword Name Server 620 “us.universalroot.com”, and the secondary Keyword Name Server 630 “uk.universalroot.com”. The notation “KNS” is a new record to identify Keyword Name Servers. By modifying the DNS software, to support the new “KNS” record, Keyword Name Servers can be identified, and to be able to communicate with one other through this invention.

(b) For 640, the keyword “japan” shown represented as “japan.keyword”, the matching Internet Protocol (IP) address for the telecommunication server is 202.232.132.75. The notation “KA” is a new record to identify the Internet Protocol (IP) address a telecommunication server. By modifying the DNS software, to support the new “KA” record, Telecommunication Servers 210 can be identified, and optimized to communicate with one another through this invention.

(c) For 650, the keyword “japan” shown represented as “japan.keyword”, the matching Keyword Name Server is “us1.keywordserver.com”. The notation “KNS” is a new record to identify Keyword Name Servers. By modifying the DNS software, to support the new “KNS” notation, Keyword Name Servers can be identified, and be able to communicate with one other through this invention.

(d) For 660, the keyword “japan” shown represented as “japan.keyword”, the matching telephone number is “1.514.282.1230”. The notation “TEL” is a new record to identify matching telephone numbers. By modifying the DNS software, to support the new “TEL” notation, it allows the DNS server to directly communicate with the Telecommunication Server 210, to facilitate a telephone call. 670, 680, 690 are alternative representations of Japanese characters in ASCII, using Trace encoding, which functions the same way as above; see (i) (a) to (d). 700, 710, 720 are alternative representations of Japanese characters in ASCII, using Race encoding, which function the same way as above; see (i) (a) to (d).

(iii) If a matching IP address “is found”, then the IP address is sent back to Name Server at ISP 115. Afterwards, Name Server at ISP 115 sends the IP address to Resolver 110 to locate the Web site for the matching IP. Then the Web site is sent via the Internet 105 to the User, for displayed by Web browser 102 on User's computer 104.

(iv) If a matching IP address “cannot be found”, then the keyword, such as “japan” is sent to a general Search Engine 175, such as YAHOO to conduct a search using the keyword. The search results, and IP address location is sent 180 back to Name Server at ISP 115. Afterwards, Name Server at ISP 115 sends the IP address to Resolver 110. Then the search engine results are sent via the Internet 105 to the User, for displayed by Web browser 102 on User's computer 104.

B. Converting a Domain Name to a Keyword and Resolving the Keyword

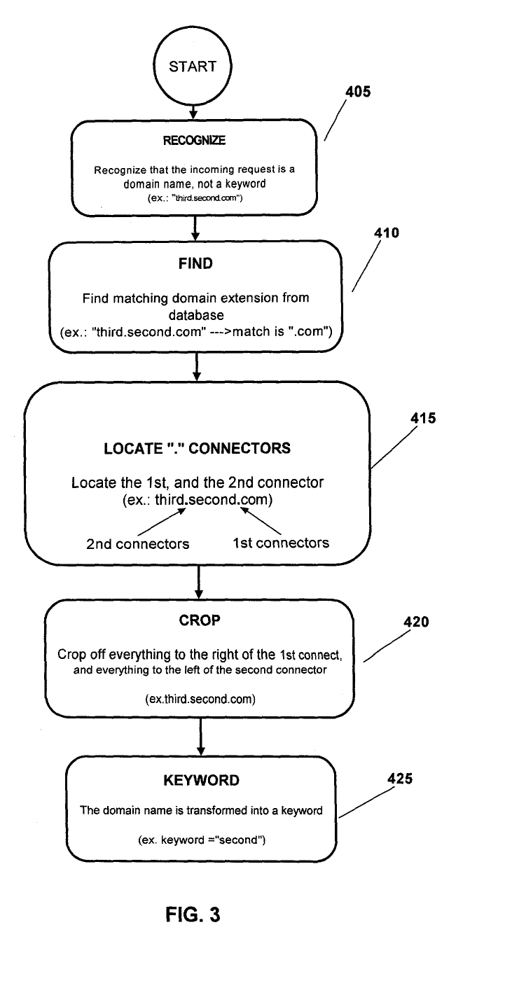

If data 155 being sent from Second Name Server 135 to Keyword Server 165 is a not a keyword, but a domain name, such as “products.chocolate.inc”, then the following steps are taken to convert the domain name to a keyword, as illustrated in FIG. 3:

(a) Recognize 405 of FIG. 3: Keyword Server 165 of FIG. 2 recognizes the incoming data 155 of FIG. 2 from Second Name Server 135 of FIG. 2 is a domain name, and not a keyword;

(b) Find 410 of FIG. 3: A search is done within Keyword Server 165 of FIG. 2 to find the matching domain name extension, which in this example is “.inc”;

(c) Locate “.” connectors 415 of FIG. 3: The server includes a computer program analyzes the domain name, and identifies the first, and the second “.” connectors. “In this case the first connector for the domain name products.chocolate.inc” is between the words products and chocolate. The second connector for the domain name “products.chocolate.inc” is between the words chocolate and inc.

(d) Crop 420 of FIG. 3: The server includes a computer program analyzes the domain name, and: (a) crops the first connector, and everything to the right of the first connector, namely the domain extension, which in this example is “.inc.”; (b) crops the second connector, and everything to the left of the first connector, which in this example is “products”;

(e) Keyword 425 of FIG. 3: The domain name, example “products.chocolate.inc” is transformed into a keyword, “chocolate”; FIG. 2, Keyword Server 165, the example “chocolate” is now a keyword. Keyword Server 165 searches 170 for the matching IP address for “chocolate”.

(i) Use the system of Section II A (i) An Exemplary System for Storing Keyword Records in a Root File of a Keyword Server and (ii) An Exemplary System of Storing the db. Zone File in a Keyword Server, above.

(ii) If a matching IP address “is found”, then the IP address is sent back to Name Server at ISP 115. Afterwards, Name Server at ISP 115 sends the IP address to Resolver 110 to locate the Web site for the matching IP. Then the Web site is sent via the Internet 105 to the User, for displayed by Web browser 102 on User's computer 104.

(iii) If a matching IP address “cannot be found”, then the keyword, such as “chocolate” is sent to a general Search Engine 175, such as YAHOO to conduct a search using the keyword. The search results, and IP address location is sent 180 back to Name Server at ISP 115. Afterwards, Name Server at ISP 115 sends the IP address to Resolver 110. Then the search engine results are sent via the Internet 105 to the User, for displayed by Web browser 102 on User's computer 104.

C. Resolving a Telephone Number or a Domain Name Used for Telecommunications

Further to Step II Example (iii) above, in the case of domain name example “JohnSmith.tel”, First Name Server 120 searches its database to see if it is authoritative for the “.tel” extension. Since the domain extension “.tel” is used for telephone communications, the domain name “JohnSmith.tel” is delegated or sent to Telephone Server 190 for resolution.

Telephone Name Server 190 then searches 195 for the matching IP address for example “JohnSmith.tel”.

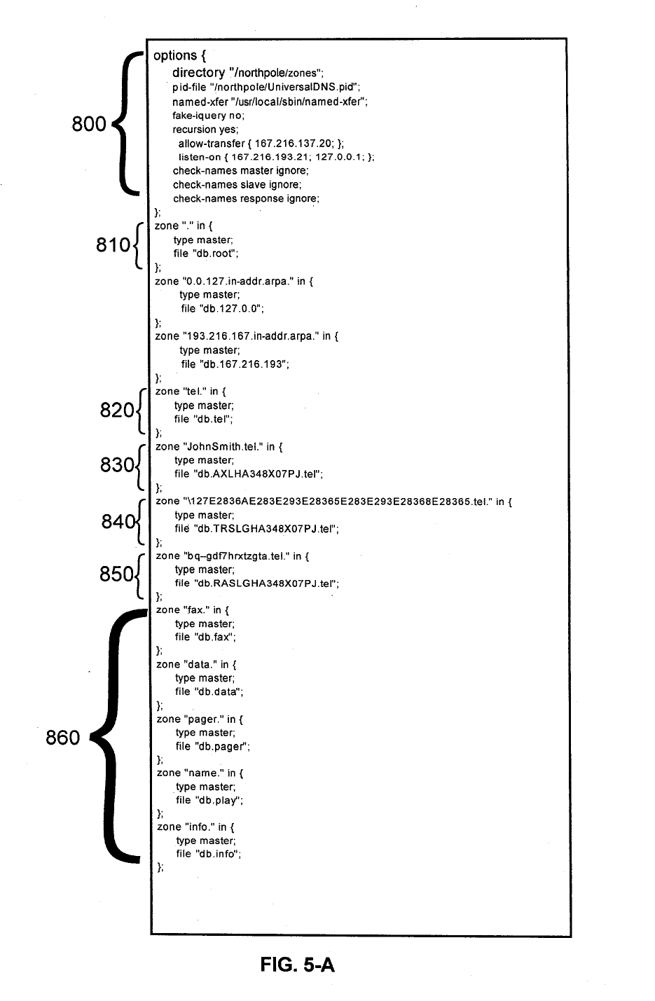

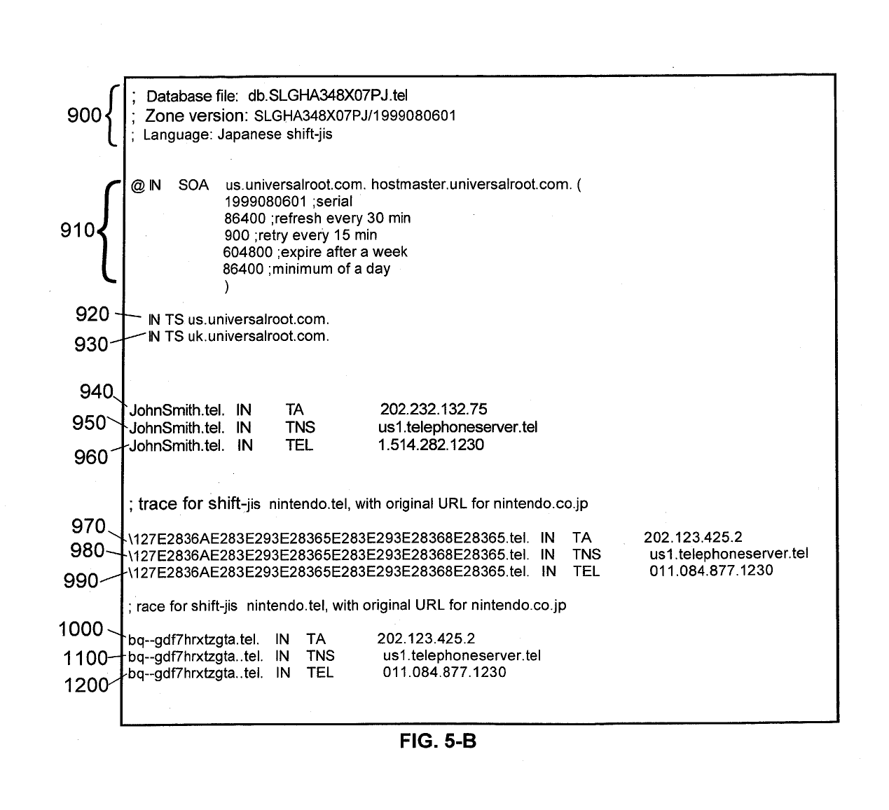

(i) An Exemplary System for Storing Telephone Records in a Root File of a Telephone Server, comprises of a Domain Name Server (DNS) software modified through this invention to support Telephones, comprising of a Root File as shown in FIG. 5-A. A standard configuration setting for a Domain Name Server (DNS) software, such as BIND is shown in 800.

The standard Domain Name Server (DNS) software has the recursion turned off, as indicated by setting it to “no”, but we will turn on the recursion by setting it to “yes”. In this example, the Telephone Server is shown as a root server, as indicated by 810 the root zone “.”; information for the “.” root zone is stored in the zone file called “db.root”. However, it is not necessarily the Telephone Server is a root server.

The first level zone 820 is “.tel”; information for the “.tel” first level zone is stored in the zone file called “db.tel”. The second level zone, contains examples, 830 to 870.

(a) Example 830 of a second level zone, is the English domain name “JohnSmith.tel”. Information for the “JohnSmith.tel” second level zone is stored in the zone file called “db.JohnSmith.tel”.

(b) Example 840 of a second level zone, is the Japanese domain name [symbol] .tel in shift-jis character encoding, stored as an ASCII representation in Trace format: “├127E2836AE283E293E28365E283E293E28368E28365.tel”. Information for the “├127E2836AE283E293E28365E283E293E28368E28365.tel” second level zone is stored in the zone file called “db.TRSLGHA348X07PJ.tel”, where “TRSLGHA348X07PJ” is a unique serial number assigned as a filename.

(c) Example 850 of a second level zone, is the domain name [symbol] .tel in shift-jis character encoding, stored as an ASCII representation in Race format: “bq—gdf7hrxtzgta.tel”. Information for the “bq—gdf7hrxtzgta.tel” second level zone is stored in the zone file called “db.RASLGHA348X07PJ.tel”, where “RASLGHA348X07PJ” is a unique serial number assigned as a filename.

(d) Example 860 are alternative representations of the .TEL first level domain extensions used, including .fax, .data, .pager, .name, and .info;

(ii) An Exemplary System of Storing the db. Zone File in a Telephone Server, comprises of a Domain Name Server (DNS) software modified through this invention to support telecommunications, comprising of a Zone File as shown in FIG. 5-B includes 900 comments. The standard Start of Authority (SOA) 910.

(a) The name of the primary Telephone Name Server 920 “us.universalroot.com”, and the secondary Telephone Name Server 930 “uk.universalroot.com”. The notation “TNS” is a new record to identify Telephone Name Servers. By modifying the DNS software, to support the new “TNS” record, Telephone Name Servers can be identified, and to be able to communicate with one other through this invention. Note, a regular Domain Name Server may be the same as a Telephone Name Server, except the settings are optimized for telecommunications (using including IPv6).

(b) For 940, the domain name “JohnSmith.tel”, the matching Internet Protocol (IP) address for the telecommunication server is 202.232.132.75. The notation “TA” is a new record to identify the Internet Protocol (IP) address of the telecommunication server. By modifying the DNS software, to support the new “TA” record, Telecommunication Servers 210 can be identified, and optimized to communicate with one each through this invention.

(c) For 950, the domain name “JohnSmith.tel”, the matching Telephone Name Server is “us1.telephoneserver.tel”. The notation “TNS” is a new record to identify Telephone Name Servers. By modifying the DNS software, to support the new “TNS” notation, Telephone Name Servers can be identified, and to be able to communicate with each other through this invention.

(d) For 960, the domain name “JohnSmith.tel”, the matching telephone number is “1.514.282.1230”. Optionally, since numbers are read from right to left in a standard DNS software, we can also reverse the telephone numbers to read 0321.282.415.1 The notation “TEL” is a new record to identify matching telephone numbers. By modifying the DNS software, to support the new “TEL” notation, it allows the DNS server to directly communicate with the Telecommunication Server 210, to facilitate a telephone call, as well as any other type of telecommunications. A host of new notations can be created for each type of communication, like MAIL is for sending electronic mail, and like MESS for instant messenging. Another option is creating a single notation (also called record) for telecommunications like TELCOM, and mapping the various telecommunication records to sub-records “tel”, “fax”, “mail”. . . etc.

970, 980, 990 are alternative representations of Japanese characters in ASCII, using Trace encoding, which functions the same way as above; see (i) (a) to (d). 1000, 1100, 1200 are alternative representations of Japanese characters in ASCII, using Race encoding, which function the same way as above; see (i) (a) to (d).

(iii) If a matching IP address “is found”, then the IP address is sent back to Name Server at ISP 115. Afterwards, Name Server 115 sends the IP address to Resolver 110 to locate the user who owns matching IP from the the registered domain name, such as “JohnSmith.tel”.

Then via a plurality of computer servers, the telephone company will automatically ring the user who owns the registered domain name, such as “JohnSmith.tel”. In this present invention, users can communicate with each other via Voice Over IP (VoP), and data over IP using for example, including a Web enabled cellular phone.

Further to the present invention, the “.tel” domain extension can be hidden from User 100, by making the “.tel” invisible on the Web browser. For example, the person would only have to type in “JohnSmith” to call John Smith, without having to type in the “.tel” extension.

Note that the notations KNS, KA, TEL, TNS, TA are just examples of how the notation can be written; other examples of alternative notations for KNS are KS, NSK, SSS . . . etc. It is limitless the way the notations can be written; the way the notations are presented and written in the examples should not limit the scope of this invention; privilege is claimed.

Conclusion, Ramifications, and Scope

Accordingly, it can be seen that I have provided a method, and system for users to easily, rapidly, and reliably locate Web page that cannot be found or has moved or does not exist anymore or is lost. It minimizes users from being frustrated by getting the annoying “page cannot be displayed” (as shown in FIG. 1); this is what a Internet user normally sees when a Web page that cannot be found or has moved or does not exist anymore or is lost.

Furthermore, this present invention also allows users to access Web sites without the need to enter a domain name into the Web browser, but instead uses multi-lingual keywords; the beauty of the invention is that no plugin is required for the Web browser to resolve the keywords, since the invention uses the DNS server directly to resolve the keyword. We hereby call the multi-lingual keywords, for identification purposes “Universal Keywords”. This simplifies the process for users to access, and to locate Web sites, without having to remember the domain name extension, such as “.com”, and it works with any non-proprietary Web browser.

Furthermore, this invention provides a way for a calling party to dial a domain name or keyword to call a receiving party; this is an alternative to dialing a telephone number. This provides a simplified way to call someone, without having to remember phone numbers. Often times people forget the phone number of the person they want to reach. It is also less expensive to call long distance, since the connection is made via a global computer network, such as the Internet.

Although the description above contains many specificities, these should not be construed as limiting the scope of the invention but as merely providing illustrations of some of the presently preferred embodiments of this invention. Various other embodiments, and ramifications are possible within it's scope.

Thus the scope of the invention should be determined by the appended claims, and their legal equivalents, rather than by the examples given.

I claim

1. Method for a plurality of users to locate Web pages, comprising of:
(a) providing a plurality of intelligent devices, with a means for storing including the following:
(i) unique words in a plurality of languages, comprising of words in the form of: keywords, domain names, characters, words, symbols, numbers, and letters (individually or collectively called “Words”);
(iii) numerical addresses for identification of intelligent devices, including Internet Protocol (IP) numbers, comprising of: IPv4 (RFC 791 compliant format), IPv6 (RFC 2460 compliant format), and other IP formats;
(b) providing a means comprising of mapping Words to numerical addresses;
(c) providing a means comprising of a software to automatically identify, and distinguish the different form of Words from one another, including distinguishing keywords from domain names;
whereby users can enter a keyword or domain name, in a plurality of languages, such as Japanese, Arabic, Hindi or Apache into any regular Web browser to consistently locate a Web site with the matching Internet Protocol address, since the invention uses a server side solution, instead of a proprietary Web browser based solution.
whereby the user is provided with a easy way to locate a Web site, in their own native language.

2. The method of 1, further including a means for converting a domain name into a keyword, in the event no matching IP address can be found for the domain name, comprising of:
(a) providing a means of re-directing a domain name to a software on a plurality of intelligent devices;
(b) providing a means to automatically identifying, and distinguishing the first level domain name, the second level domain name, the third level and higher level domain names;
(c) providing a means to retain the second level domain portion of the entire domain name, while cropping off the following portions: the first level domain, the third level domain and any higher level domains;
whereby the newly converted second level domain is equivalent to a keyword, used to re-locate: lost Web pages, Web pages that have moved, missing Web pages, and non-existent Web pages;
whereby the user will be automatically re-directed to a Web site for Web pages that cannot be found via the domain name, thus offering the user a more convenience and a more pleasurable experience;

3. The method of 1, whereby the intelligent device is a computer;

4. The method of 1, further providing a means for re-directing only the second level domain portion of the entire domain name;

5. The method of 1, further including providing a means, consisting of a software for matching the second level domain portion of the entire domain name (also called “keyword”) with a numerical addresses;

6. The method of 1, further including providing a means for re-directing the domain name to a general search engine;

7. The method of 1, further including providing a means for automatically processing a re-directed keyword or domain name within a general search engine;

8. The method of 1, further including providing a means for re-directing, including the second level domain portion of the entire domain name (herein step 5 called “Keyword”) to a general search engine, consisting of:
(a) providing a means for automatically intercepting, and inputting the Keyword into the search engine;
(b) providing a means for automatically actuating a search in the general search engine using the Keyword;
(c) providing a means for sending the Web page with the search results back to the user;

9. The method of 1, further including means of locating Web sites using multilingual Words, without the need of any additional end user software other than a regular Web browser;

10. The method of 1, further including a software on a Web browser for distinguishing keywords from domain names;

11. The method of 1, further including means, and systems for users to register domain names, and keywords as top level domains;

12. The method of 1, further including means of verifying the existence of a Web page, comprising of pinging the numerical address of a intelligent device;
whereby the user will be automatically re-directed to a search results Web page when Web pages have moved, is missing, is lost, and is non-existent; whereby users do not have to get the annoying cannot be found Web page, thus offering the user more relevant searches, as well as saving their time;

13. Method of providing peer-to-peer computer sites, comprising of:
(a) assigning numerical addresses to each personal intelligent device;
(b) a means for hosting a computer site on each personal intelligent device;
(c) a means for identifying live and dead computer sites, across a global communications network;
(d) a means for locating computer sites on a plurality of intelligent devices, across a global communications network;
(e) a means to link live computer sites peer-to-peer, across a global communications network;
whereby users will be able to economically host their own Web sites at home or at a work; the method also allows users to identify and display only live computer sites (when the persons computer is turned on); an example of usage include sharing scientific data via Web sites connected to a home computer, on a television cable network or a DSL network;

14. Method for a calling party to communicate with a receiving party on a global communications network, comprising of:
(a) providing a plurality of intelligent devices, with a means, and a system for storing including the following:
(i) unique words in a plurality of languages, comprising of words in the form of: keywords, domain names, characters, words, symbols, numbers, and letters (individually or collectively called “Words”);
(ii) numerical addresses for identification of Intelligent devices;
(iii) telecommunication identifiers, consisting of telephone numbers, facsimile numbers, data numbers, e-mail addresses, messenging addresses, pager numbers, device identification numbers, and product identification numbers;
(b) providing a means for the intelligent devices to intercept the Words, telecommunication identifiers and numerical addresses;
(c) providing a means consisting of a software, including a Domain Name Service (DNS) software for mapping the Words, the telecommunication identifiers and the numerical addresses to one another;
(d) providing a means of transmitting individually or in combination: the Words, the telecommunication identifiers and the numerical addresses to a plurality of intelligent devices;
whereby it would be a great benefit for users to not have to dial a telephone number to call another party, but instead dialing easy to remember Words into a telephone, in a plurality of languages, such as [symbol] .tel or “JohnSmith*tel” or “John Smith”.
whereby, it would be beneficial since people do not have to switch telephone numbers when they move residence. Also, people can save on long distance charges, since the telephone connection can be made via the Internet using Voice Over Internet Protocol (IP) technology.

15. The method of 14, further including a means for connecting a calling party to a receiving party, by dialing a Word, into a telecommunication device;

16. The method of 14, further including mapping a Word name to another Word;

17. The method of 14, further including mapping numerical addresses directly to other numerical addresses;
whereby it would allow Domain Name Service (DNS) computer servers to link with one another for telephone and telecommunication services in a decentralize system, without the need of proprietary DNS software or proprietary telephone software or propriety DNS servers;

18. The method of 14, further:
(a) whereby the Words are in audio format;
(b) converting Words in audio format to matching equivalent Words in text format;
whereby it would allow people to conveniently use voice activated Words on a telephone to call another calling party, such as for example: “Call John Smith” or “Fax John Smith” or “Email John Smith”, without the need of a telephone number;

19. The method of 14, further including a means for converting a Word in multilingual format, into an equivalent representation in ASCII format;

20. The method of 14, further comprising of a means for identifying, and processing Words, telecommunication records, and intelligent device records, within a domain name service (DNS) software, including the BIND domain name service software.

21. The method of 14, further comprising of a means for processing long distance telecommunication identifiers;
whereby many people can conveniently use easy to remember Words, instead of telephone numbers to send, and receive all types of communications, including voice, data, facsimile or pager communications over a global computer network, such as the Internet;

22. Method for unified communications by matching the Words to numerical address that identifies intelligent devices comprising of:
(a) linking a unique Word to a unique numerical address;
(b) using a flag on the Word as a unique identifier for each type of telecommunication;
(c) providing a means of distinguishing the type of telecommunication for incoming, and outgoing transmissions via the flag on the Word;
whereby each identifier can distinguish the different types of telecommunications, such as comprising of voice, data, facsimile, and pager, for more efficient routing of computer packets;

23. The method of 22, whereby the flag on the Word is a domain name extension;

24. The method of 22, further using including the using the star “*” key, in combination with other keys on a Internet ready device to initiate a telecommunication transmission over Internet Protocol;

25. The method of 22, further comprising of using the star key “*” on the numerical keypad of a telecommunication device to represent the dot “.” connector of a domain name;

26. The method of 22, further comprising of a means to identify, and to process the “*”, as equivalent to a dot “.” of a domain name, on the computer server;
whereby it would be a great benefit for users to use a regular telephone to dial a domain name, such as “JohnSmith*tel”;

27. The method of 22, further:
(a) whereby the Words are in audio format;
(b) converting Words in audio format to matching equivalent Words in text format;
whereby it would allow people to conveniently use voice activated Words on a telephone to call another calling party, such as for example: “Call JohnSmith*tel” or “Fax JohnSmith*fax” or “Email JohnSmith*mail”, without the need of a telephone number;

28. The method of 22, further including the .TEL domain extension being used for telephone communications;

29. The method of 22, further including the .FAX domain extension used for facsimile communications;

30. The method of 22, further including the .DATA domain extension being used for data communications;

31. The method of 22, further including the .PAGER domain extension being used for paging communications;

32. The method of 22, further including the .PLAY domain extension being used for computer gaming communication;

33. The method of 22, further including the .MUSIC domain extension being used for audio communications;

34. The method of 22, further including the .SHOP domain extension being used for electronic commerce communications;

35. The method of 22, further including the .NEWS domain extension being used for electronic news communications;

36. The method of 22, further including the .MOVIE domain extension being used for video transmissions;

37. The method of 22, further including the .CHAT domain extension being used for chat transmissions;
whereby the different domain name extensions can not only allow for unified communications, but it can also distinguish each type of packet transmission, allowing computer servers to automatically optimized transmission more efficiently, and faster, since the servers can know what they are receiving or transmitting before hand. An example is if we can identify bandwidth heavy streaming videos, it can be re-routed to the most efficient video servers for processing or more secure re-routing for e-commerce sites;
